(19) United States
(12) Patent Application Publication
(10) Pub. No.: US 2020/0329894 A1
(43) Pub. Date: Oct. 22, 2020

(54) Rollable Portable Photography Background Mat

(71) Applicant: Kathleen Leahy Ignatowski, Raleigh, NC (US)

(72) Inventor: Kathleen Leahy Ignatowski, Raleigh, NC (US)

(21) Appl. No.: 16/501,445

(22) Filed: Apr. 17, 2019

(51) Int. Cl. A47G 27/02

(52) U.S. Cl. CPC A47G 27/0243; B32B 2250/05; B32B 2309/10; B65H 2701/1922

(57) ABSTRACT

A photography background mat that rolls up into a cylindrical shape making it easy to transport. The inventive device includes a top layer of woven fabric ideal for a photography background, two or more layers of woven fabric, and two or more layers of adhesive as required to bond all layers of woven fabric. The mat can also include a bottom layer of woven fabric ideal for a photography background, making the mat dual sided. When the user is finished photographing products on the present invention, the user simply rolls up the invention into a cylindrical shape without the mat wrinkling or collapsing into a fold.

### CROSS-REFERENCE TO RELATED APPLICATIONS

Provisional Application No. 62/659,802

### STATEMENT REGARDING FEDERALLY SPONSORED RESEARCH OR DEVELOPMENT

Not applicable

### REFERENCE TO SEQUENCE LISTING, A TABLE, OR A COMPUTER PROGRAM LISTING COMPACT DISC APPENDIX

Not applicable

### BACKGROUND

This invention relates to photography background mats, specifically mats that are portable and made with pressed woven fabric. Photography background mats are commonly used by photographers to photograph small products since they lay flat and provide a pressed woven fabric background. Current background mats are made of pressed fabric glued to a rigid surface like a board to stabilize the fabric and prevent it from folding and wrinkling. The large rigid shape and size, typically about 18″ wide×25″ long, or larger, makes them difficult and cumbersome to travel with. Simply using a folded-up piece of fabric alone does not work because it will wrinkle and crease during transport and storage. Then the photographer will have to spend time ironing the fabric before using it for a pressed fabric background.

This invention takes a unique approach by autogenously bonding the pressed woven fabric to two or more layers of woven fabric, which makes the pressed state of the fabric permanent, keeping it free of wrinkles throughout transport, adds strengthen and stiffness so the fabric can roll without easily collapsing into a fold and thus causing a crease, and offers a more compact, cylindrical shape that is easier to transport.

Prior art describes interfacing fabric, which does provide stiffness, but one layer will not prevent the mat from easily collapsing into a fold and causing a crease.

See Class 442, Subclass 264: Woven fabrics in three or more distinct layers where the fabrics have been bonded autogenously by an adhesive layer.

### BRIEF SUMMARY OF THE INVENTION

This invention presents a photography background mat that rolls up into a cylindrical shape, which is easier to transport than prior firm backgrounds.

A primary object of the present invention is to provide a rollable and portable photography background mat that is easier to transport than prior art devices.

### BRIEF DESCRIPTION OF THE SEVERAL VIEWS OF THE DRAWINGS

FIG. 1 is a cross sectional view showing the layers of woven fabric with layers of adhesive, corresponding to claim 1.

FIG. 2 is a cross sectional view showing the layers of woven fabric with layers of adhesive, including a bottom layer to create a dual sided background mat, corresponding to claim 9.

FIG. 3 is a cross sectional view showing the layers of woven fabric with layers of fusible interfacing, a layer of adhesive, and a bottom layer to create a dual sided background, corresponding to claim 17.

FIG. 4 is a cross sectional view of the final bonded layers laying flat as one mat.

FIG. 5 is an upper perspective view of the present invention in the cylindrical rolled up positon.

### DETAILED DESCRIPTION OF THE INVENTION

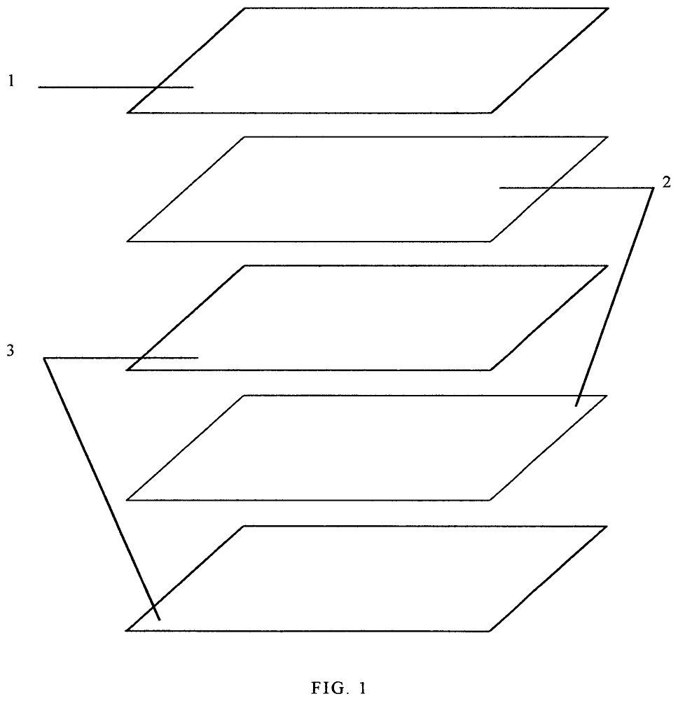

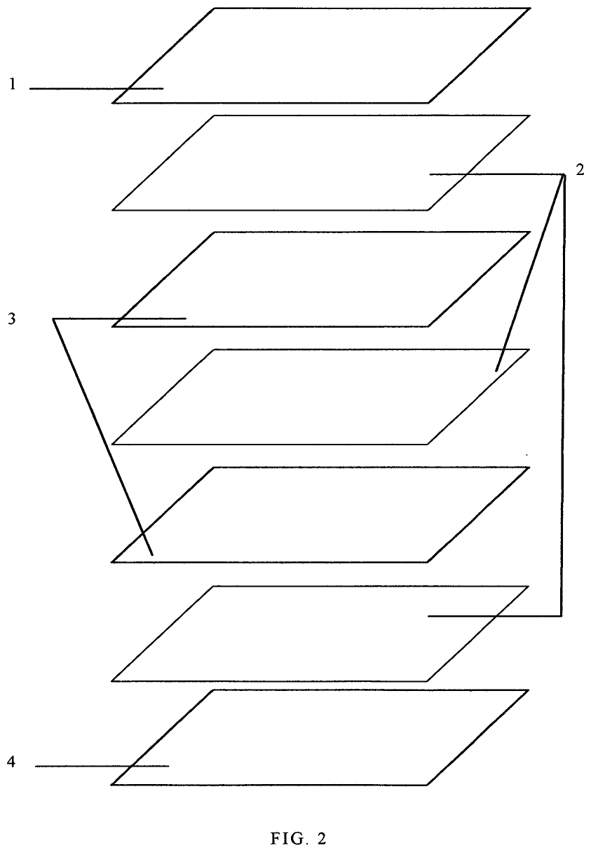

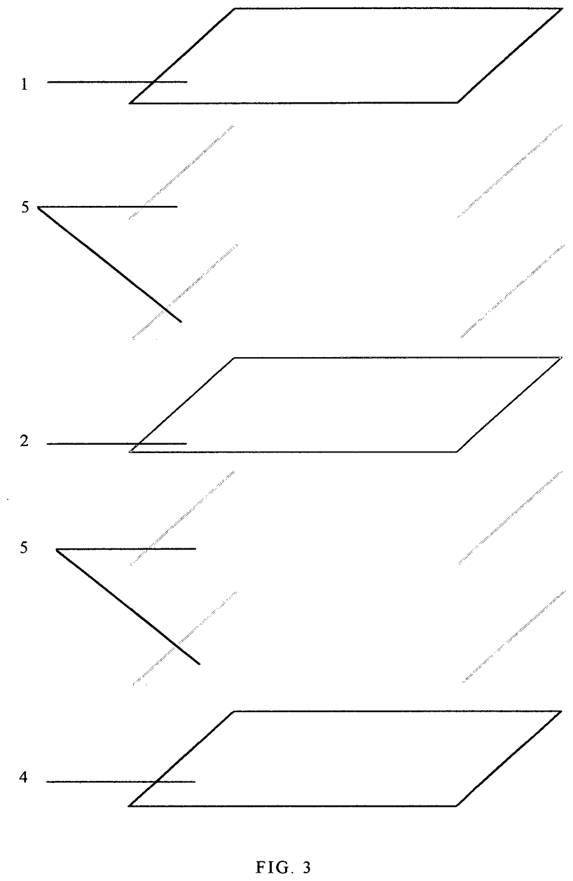

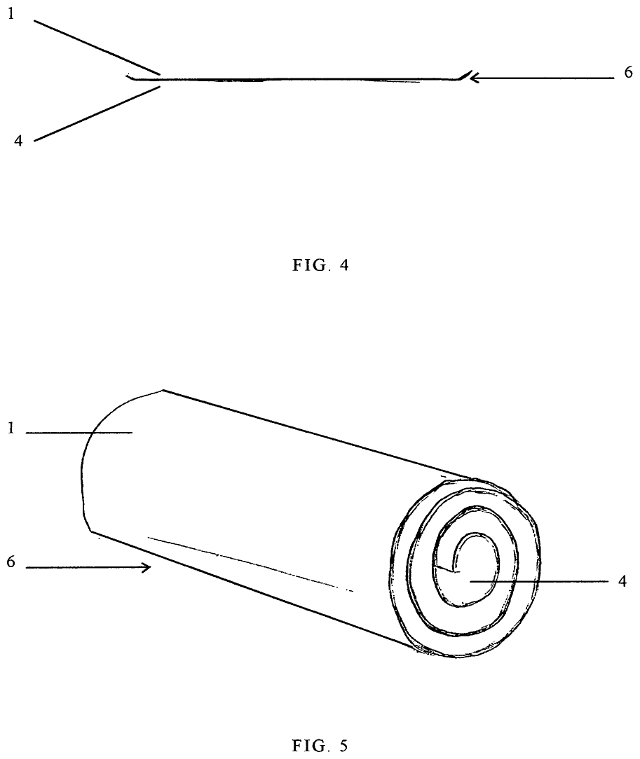

Now turning descriptively to the drawings, in which similar reference characters denote similar elements through the several views, FIGS. 1 through 5 illustrate a portable background mat, which comprises of a top layer of woven fabric 1, layers of adhesive 2, and additional layers of woven fabric 3. FIGS. 2 and 3 illustrate an additional layer of adhesive and bottom layer which can be used as a background in addition to the top layer. FIG. 3 illustrates fusible interfacing 5, which is woven fabric with adhesive already applied to one side, as an alternative to separate pieces of woven fabric and adhesive to achieve a similar final product. FIG. 4 illustrates the portable background mat as a final piece laying flat. FIG. 5 illustrates the mat rolled in a cylindrical shape for portability.

The key differentiator in this invention is the layered bonding which creates just the right amount of tension and stiffness to roll up instead of folding easily. Woven fabric, such as linen, on its own will naturally fold vs rolling into a cylindrical shape. Woven fabric also wrinkles easily during transport. This invention uses flexible dual sided adhesive and layers of cotton instead of a firm board to achieve a permanent press in the top and bottom layers (reference characters 1 and 4 in FIG. 2) as well as the portability of the cylindrical shape (FIG. 5).

The process for making a rollable photography background is to first cut the desired fabric you want to use as a background. Iron the piece to remove all wrinkles. Set aside.

Decide how many layers of fabric you want for bonding to add strength and stiffness. Three to five layers are ideal so the mat is thin enough to roll easily in a tight cylindrical shape but thick enough to that it will not dent easily. All woven fabric (reference characters 2 in FIG. 1-2) will work. Cotton is a good option because it is flexible and inexpensive. Thinner cotton will require more layers while thicker cotton, like canvas will require less layers. For example, 3 layers of canvas will result in about the same flexibility of 4 or 5 layers of thin cotton. For this process explanation, I describe using two layers of cotton as illustrated in FIG. 2.

Cut out the layers of cotton in the came size as the top layer. Iron any wrinkles out of the cotton.

Chose and cut a bottom layer of woven fabric (reference characters 4 in FIG. 2) in the same size as the top layer. Iron any wrinkles out of the woven fabric.

Next chose a dual sided fusible and flexible fabric adhesive (reference characters 2 in FIG. 1-2) that bonds to fabric through heat and pressure. Cut enough pieces to bond between each layer of fabric, in the same size as the top layer (reference characters 1 in FIG. 1-2) and additional layers of fabric (reference characters 3 in FIG. 1-2). For this example, cut three pieces of adhesive (reference characters 2 in FIG. 2).

Now bond one side of the adhesive to the top layer of fabric (Item 1 in FIG. 2) using an iron or larger heat press. Each adhesive comes with its own instructions, but they typically require a minimum iron temperature and minimum pressing time. When the adhesive is bonded to one side of the top layer, set aside to cool.

Repeat for the two layers of cotton (reference characters 3 in FIG. 2).

Once cool, remove the paper backing from the adhesive on both the top layer and layers of cotton. Next assemble the layers as illustrated in FIG. 2.

Next bring the assembled layers back to your ironing table and apply the iron or heat press to the top layer, again following the adhesive instructions for minimum heat and pressing time. Cover the entire piece in one press or in sections if your iron or heat press is smaller than your background.

It is important to create a pressing table that is at least the size of your background mat so the mat will lay flat through the pressing process and then cool flat.

Allow to cool.

Trim the edges to the final size and shape if required. Sewing the edges is not required but it provides a clean finished look.

What is claimed is:

1. A rollable fabric mat comprising:
a. a top layer of woven fabric and
b. at least two additional layers of woven fabric bonded to said top layer of woven fabric with fusible adhesive.

2. The rollable fabric mat of claim 1, wherein said additional layers of woven fabric are comprised of cotton.

3. The rollable fabric mat of claim 2, wherein the shape of the mat is rectangular.

4. The rollable fabric mat of claim 3, wherein the width of the mat is at least fifteen inches.

5. The rollable fabric mat of claim 2, wherein said top layer of woven fabric is comprised of linen.

6. The rollable fabric mat of claim 2, wherein said top layer of woven fabric is comprised of wool.

7. The rollable fabric mat of claim 2, wherein said top layer of woven fabric is comprised of cotton.

8. The rollable fabric mat of claim 2, wherein said top layer of woven fabric is comprised of silk.

9. A rollable fabric mat comprising:
a. a top layer of woven fabric;
b. at least two additional layers of woven fabric bonded to said top layer of woven fabric with fusible adhesive; and
c. a bottom layer of woven fabric bonded to said additional layers of woven fabric with fusible adhesive.

10. The rollable fabric mat of claim 9, wherein said additional layers of woven fabric are comprised of cotton.

11. The rollable fabric mat of claim 10, wherein the shape of the mat is rectangular.

12. The rollable fabric mat of claim 11, wherein the width of the mat is at least fifteen inches.

13. The rollable fabric mat of claim 10, wherein said top and bottom layers of woven fabric are comprised of linen.

14. The rollable fabric mat of claim 10, wherein said top and bottom layers of woven fabric are comprised of wool.

15. The rollable fabric mat of claim 10, wherein said top and bottom layers of woven fabric are comprised of cotton.

16. The rollable fabric mat of claim 10, wherein said top and bottom layers of woven fabric are comprised of silk.

17. A rollable fabric mat comprising:
a. a top layer of woven fabric;
b. at least two layers of fusible woven interfacing;
c. at least one layer of fusible adhesive; and
d. a bottom layer of woven fabric.

18. The rollable fabric mat of claim 17, wherein the shape of the mat is rectangular.

19. The rollable fabric mat of claim 18, wherein the width of the mat is at least fifteen inches.

20. The rollable fabric mat of claim 17, wherein said top and bottom layers of woven fabric are comprised of linen.

21. The rollable fabric mat of claim 17, wherein said top and bottom layers of woven fabric are comprised of wool.

22. The rollable fabric mat of claim 17, wherein said top and bottom layers of woven fabric are comprised of cotton.

23. The rollable fabric mat of claim 17, wherein said top and bottom layers of woven fabric are comprised of silk.
